(19) United States
(12) Patent Application Publication
(10) Pub. No.: US 2005/0221987 A1
(43) Pub. Date: Oct. 6, 2005

(54) Use of certain phospholipids to deliver hormonal effects to plants

(76) Inventors: Keith Rowley, Madison, WI (US); Sang Won Jeong, Madison, WI (US); Keith Cowan, Stockholm (SE)

Correspondence Address: QUARLES & BRADY LLP, 411 E. WISCONSIN AVENUE, SUITE 2040, MILWAUKEE, WI, 53202-4497, US

(21) Appl. No.: 11/044,365

(22) Filed: Jan. 27, 2005

Related U.S. Application Data
(60) Provisional application No. 60/539,456, filed on Jan. 27, 2004.

(51) Int. Cl. A01N 57/18; C07F 9/28

(52) U.S. Cl. 504/206; 562/17

(57) ABSTRACT

The structures of N-acyl phosphatidylethanolamines, N-acyl lysophosphatidylethanolamines, deoxy N-acyl lysophosphatidylethanolamines, N-acyl glycerophosphorylethanolamines, and deoxy N-acyl glycerophosphorylethanolamines that can deliver an ethylene- or cytokinin-like effect to a plant or plant part are disclosed. Also disclosed are methods of using the compounds to achieve an ethylene- or cytokinin-like effect.

### CROSS-REFERENCE TO RELATED APPLICATIONS

This application claims the benefit of U.S. provisional application 60/539,456, filed on Jan. 27, 2004, which is incorporated by reference in its entirety.

### STATEMENT REGARDING FEDERALLY SPONSORED RESEARCH OR DEVELOPMENT

Not applicable.

### BACKGROUND OF THE INVENTION

Since many plants and plant parts are of economic importance to people, people have learned to manipulate the life cycle of plants for their own purposes. Various chemical and biological agents have been used on commercially grown fruits and vegetables to control the timing of their ripening. Some agents are used to synchronize the ripening of fruits and vegetables for more efficient harvest. Other agents are used to prevent premature fruit drop. Some ripening agents have also been used to enhance color development in fruits and vegetables for better and more uniform color, as expected by retail consumers. In the United States, it is current practice to treat many types of fruits and vegetables with one or more such agents during the growing season and after harvest.

In recent years, naturally derived materials with good ripening effects have been identified. For example, certain phospholipids (such as lysophosphatidylethanolamine (LPE) and lysophosphatidylinositol (LPI)) have been shown to accelerate fruit ripening. Farag, K. M. et al., Physiol. Plant, 87:515-524 (1993); Farag, K. M. et al., HortTech., 3:62-65 (1993); Kaur, N., et al., HortScience, 32:888-890 (1997); Ryu, S. B., et al., Proc. Natl. Acad. Sci. U.S.A., 94:12717-12721 (1997); U.S. Pat. Nos. 5,126,155 and 5,110,341; and WO 99/23889.

Besides ripening, it is also important to the plant industry to manipulate the size, weight, number, and other characters of various plant parts to enhance the production and to make the plant products more appealing to consumers. Therefore, agents that can affect the ripening, size, weight, number, and various other characters of various plant organs and tissues are desirable in the plant industry.

### BRIEF SUMMARY OF THE INVENTION

The present invention provides new compounds and methods for delivering hormonal effects to plants or a part thereof to achieve various desirable effects.

In one aspect, the present invention relates to a compound having the formula R¹OCH₂—R²CH—CH₂OP(O)(OH)O—CH₂CH₂N(R³)—COR⁴, wherein R¹ and R³ are hydrogen or carbon chains of one to 24 carbons, R² is hydrogen or a group having the formula R⁵O wherein R⁵ is hydrogen or a carbon chain of one to 24 carbons, and R⁴ is hydrogen or a carbon chain of one to 23 carbons; the carbon chains can be saturated, unsaturated, linear, branched, cyclic, or polycyclic; and the carbon chains can have heteroatoms. In one embodiment of the invention, R¹ is a carbon chain and R² is R⁵O wherein R⁵ is also a carbon chain. The corresponding compounds are named N-acyl phosphatidylethanolamines (N-acyl-PEs). In another embodiment, R² is R⁵O and either R¹ or R⁵, but not both, is hydrogen. The corresponding compounds are named N-acyl lysophosphatidylethanolamines (N-acyl-LPEs). In another embodiment, R¹ is a carbon chain and R² is hydrogen. The corresponding compounds are named deoxy N-acyl-LPEs. In another embodiment, R¹ is hydrogen and R² is R⁵O wherein R⁵ is hydrogen. The corresponding compounds are named N-acyl glycerophosphorylethanolamines (N-acyl-GPEs). In another embodiment, both R¹ and R² are hydrogen. The corresponding compounds are named deoxy N-acyl-GPEs.

In another aspect, the present invention relates to a method of delivering an ethylene- or cytokinin-like effect to a whole plant or plant part by treating the plant or plant part with one or more of the compounds defined above in an amount effective to deliver the ethylene-like or cytokinin-like effect and optionally observing the effect. The ethylene-like effects that can be delivered include but are not limited to enhancement of ripening or maturation of a plant part, enhancement of color change of a fruit or leaf, size reduction in a plant or plant part, and promotion of cotton boll opening. The cytokinin-like effects that can be delivered include but are not limited to maintaining or enhancing plant vigor, increasing the number or size of a plant or plant part, chlorophyll retention, and enhancement of production of a plant part on a growing plant.

In another aspect, the present invention relates to a method for promoting growth, color development, or both in a plant or plant part by treating the plant or plant part with one or more of the compounds defined above in an amount effective to promote the growth of the plant or plant part and optionally observing the effect achieved.

### BRIEF DESCRIPTION OF THE SEVERAL VIEWS OF THE DRAWINGS

Not applicable.

### DETAILED DESCRIPTION OF THE INVENTION

It is disclosed here that N-acyl-PEs, N-acyl-LPEs, deoxy N-acyl-LPEs, N-acyl-GPEs, and deoxy N-acyl-GPEs can deliver hormonal effects on plant growth that result in changes in the life cycle of growing plants and plant parts. In particular, the compounds as defined below can be used to mimic the effects of the plant hormones ethylene and cytokinin. This is demonstrated in the examples below using representative compounds N-acetyl phosphatidylethanolamine (NAPE-2, cytokinin-like activity) and N-acetyl lysophosphatidylethanolamine (NALPE-2, ethylene-like activity) and the art-recognized radish cotyledon bioassay. Further, the direct biological effects of some of the compounds as growth or color development agents are also demonstrated in the examples by their ability to promote cotyledon expansion (growth promotion), to increase the level of anthocyanin (a pigment in many plant parts), and to accelerate color development in fruits. Additional details on which of the two types of hormonal activities that other compounds of the present invention have can be readily determined by a skilled artisan through routine experimentation with the assay systems described in the examples or other systems with which a skilled artisan is familiar. For example, a skilled artisan can measure the effect of a particular N-acyl-PE, N-acyl-LPE, deoxy N-acyl-LPE, N-acyl-GPE, or deoxy N-acyl-GPE on cotyledon expansion. If the cotyledon expansion is enhanced, the compound is determined to have cytokinin-like activity. If the cotyledon expansion is inhibited, the compound is then determined to have ethylene-like activity. Similarly, additional details on the growth and color promoting activities of other compounds of the present invention can be readily determined by a skilled artisan through routine experimentation with the assay systems described in the examples or other systems with which a skilled artisan is familiar.

The N-acyl-PEs, N-acyl-LPEs, deoxy N-acyl-LPEs, N-acyl-GPEs, and deoxy N-acyl-GPEs that can mimic the effects of ethylene or cytokinins and can be used to promote growth and/or color development in a plant or plant part are defined by the formula R¹OCH₂—R²CH—CH₂OP(O)(OH)O—CH₂CH₂N(R³)—COR⁴, wherein R¹ and R³ are hydrogen or carbon chains of one to 24 carbons, R² is hydrogen or a group having the formula R⁵O wherein R⁵ is hydrogen or a carbon chain of one to 24 carbons, and R⁴ is hydrogen or a carbon chain of one to 23 carbons; the carbon chains can be saturated, unsaturated, linear, branched, cyclic, or polycyclic; and the carbon chains can have heteroatoms. Examples of heteroatoms that can attach to the carbon chains of R¹ and R³-R⁵ include but are not limited to N, S, O and Cl. In one preferred embodiment, at least one of R¹ and R³-R⁵ is an alkyl, alkenyl, or alkynyl substituted with at least one substituent selected from halogen, amino, alkoxy, carboxy, alkoxycarbonyl, alkylcarbonyl, or hydroxy. In another preferred embodiment, one or more of the carbon atoms in at least one of the R¹ and R³-R⁵ groups is replaced by a constituent selected from an ester group, a nitrile, an amine, an amine salt, an acid, an acid salt, an ester of acids, a hydroxyl group, a halogen group, or a heteroatom selected from an oxygen, a sulfur, a nitrogen, or a phosphorus.

Ethylene is a plant hormone and is the only member of its class. All higher plants produce ethylene. The ethylene production varies with the type of tissue, the plant species, and the stage of development (Salisbury, F B and Ross, C W (1992) Plant Physiology, Belmont, Calif.: Wadsworth. pp. 357-407, 531-548; and McKeon, T A, et al. (1995) Biosynthesis and metabolism of ethylene, In P J Davies (ed) Plant Hormones: Physiology, Biochemistry and Molecular Biology, Dordrecht: Kluwer. pp. 118-139, both of which are incorporated by reference in their entirety). Ethylene is known to be able to stimulate the maturation and ripening of a plant or plant part. For example, the production of ethylene has been manipulated to modulate fruit ripening and color change. Ethylene can also be used to reduce the size of a plant or plant organ. Ethylene is also known to stimulate leaf and fruit abscission, flower opening, Bromeliad flower induction, flower and leaf senescence, shoot and root growth and differentiation, adventitious root formation, release from dormancy, and femalesness in dioecious flowers (Davies P J (1995) Plant Hormones: Physiology, Biochemistry and Molecular Biology, Dordrecht: Kluwer Academic; Mauseth, J D (1991) Botany: An Introduction to Plant Biology, Philadelphia, Saunders. pp. 348-415; Raven, P H et al. (1992) Biology of Plants, New York: Worth. pp. 545-572; and Salisbury, F B and Ross, C W (1992) Plant Physiology, Belmont, Calif.: Wadsworth. pp. 357-407, 531-548, all of which are incorporated by references in their entirety). For field crops or parts in particular, such as cotton bolls, ethylene can promote opening.

It is expected that various N-acyl-PEs, N-acyl-LPEs, deoxy N-acyl-LPEs, N-acyl-GPEs, and deoxy N-acyl-GPEs that have ethylene-like activities can be used to mimic one or more of the effects of ethylene such as those described above. For example, one can use the N-acyl-PEs, N-acyl-LPEs, deoxy N-acyl-LPEs, N- acyl-GPEs, or deoxy N-acyl-GPEs to enhance the ripening or maturation of a plant or plant part, such as ripening or maturation of a fruit or vegetable, to enhance the color change of a fruit or vegetable, or to reduce the size of a plant or plant part, such as the pod or fruit size. The ripening or maturation of a plant part (e.g., a fruit, a flower, a seed, a leaf, a root, a stem, a tuber, or a bulb) can be enhanced regardless of whether the plant part is still on a growing plant or has been harvested from the plant.

Cytokinins belong to a class of plant hormones that can promote cytokinesis (cell division). There are over 200 natural and synthetic cytokinins. Structurally, cytokinins resemble adenine and are produced in plants by biochemical modification of adenine (McGaw, B A (1995) Cytokinin biosynthesis and metabolism, In P J Davies (ed) Plant Hormones: Physiology, Biochemistry and Molecular Biology, Dordrecht: Kluwer. pp. 98-117, incorporated by reference in its entirety; and Salisbury, F B and Ross, C W (1992) Plant Physiology, Belmont, Calif.: Wadsworth. pp. 357-407, 531-548). Cytokinins have been found in almost all higher plants as well as mosses, fungi, and bacteria and also in tRNA of many prokaryotes and eukaryotes. The first identified cytokinin, kinetin, is a natural compound that is not made in plants. Although a natural compound, kinetin is sometimes referred to as a “synthetic” cytokinin by some people to indicate its non-plant origin. The most commonly made cytokinin by plants is zeatin, which was first isolated from corn (Zea mays).

In plants, cytokinin concentrations are the highest in meristematic regions and areas of continuous growth such as roots, young leaves, developing fruits, and seeds (Arteca, R (1996) Plant Growth Substances: Principles and Applications, New York: Chapman & Hall; Mauseth, J D (1991) Botany: An Introduction to Plant Biology, Philadelphia, Saunders. pp. 348-415; Raven, P H et al. (1992) Biology of Plants, New York: Worth. pp. 545-572; Salisbury, F B and Ross, C W (1992) Plant Physiology, Belmont, Calif.: Wadsworth. pp. 357-407, 531-548). This is consistent with the cytokinesis activity of the cytokinins. Besides promoting cytokinesis, depending on the particular cytokinin and plant species, some other physiological effects of cytokinesis include stimulation of morphogenesis (shoot initiation/bud formation), stimulation of the growth of lateral buds (release of apical dominance), stimulation of cell enlargement resulting in larger plant or organ size (e.g., larger pod size, leaf size or fruit size), stimulation of stomatal opening, promotion of the conversion of etioplasts into chloroplasts by stimulating chlorophyll synthesis, and retention of chlorophyll in mature plant parts such as leaves.

It is expected that various N-acyl-PEs, N-acyl-LPEs, deoxy N-acyl-LPEs, N-acyl-GPEs, and deoxy N-acyl-GPEs that have cytokinin-like activities can be used to mimic one or more of the effects of cytokinins such as those described above. For example, the N-acyl-PEs, N-acyl-LPEs, deoxy N-acyl-LPEs, N-acyl-GPEs, or deoxy N-acyl-GPEs can be used to maintain or enhance plant vigor, to enhance the number or size of flowers and fruits on a growing plant, and to maintain lawn or grass through green pigment retention.

In one aspect, the present invention relates to a method of delivering an ethylene-or cytokinin-like effect to a plant or plant part by treating the plant or plant part with one or more of the compounds of the present invention.

In another aspect, the present invention relates to a method for promoting the growth of a plant or plant part by treating the plant or plant part with one or more of the compounds of the present invention. The method can be practiced to increase the size and/or weight of a plant part. The size of a plant part refers to its volume. A skilled artisan knows how to measure and compare the size of a particular plant part. For example, for a substantially round fruit, diameter can be used as a measure of fruit size. For leaves that have similar thickness, the surface area can be used as an indication of leave size. The present invention is particularly useful for increasing the size and/or weight of various fruits, foliage, flowers, and tubers. The method can also be practiced to enhance root formation and development of roots on cuttings (increase the number of roots and/or overall length of the roots) and to enhance tuber or bulb formation (increase the number of tubers or bulbs). The method can further be practiced to stimulate turf grass growth (e.g., increase dry weight or biomass of turf grass).

In another aspect, the present invention relates to a method of promoting color development in a plant part by treating the plant part with one or more of the compounds of the present invention. In one embodiment, the method is practiced to promote color development in fruits or leaves. Examples of target fruits include but are not limited to grapes, plums, cherries, strawberries, apples, citrus, tomatoes, and peppers.

The ethylene- and cytokinin-like effects as well as the growth and color promotion effects of the compounds of the present invention are not limited to any particular plant or plant part. Treatment conditions for applying a compound of the present invention to a plant or plant part, such as treatment time, treatment temperature, and the amount of a compound used for a particular application, may vary depending on variables such as the specific compound used, the particular plant part treated, and the purpose of the treatment. Appropriate treatment conditions for any particular application can be readily determined by a skilled artisan through routine experimentation.

Any suitable method for applying an N-acyl-PE, N-acyl-LPE, deoxy N-acyl-LPE, N-acyl-GPE, or deoxy N-acyl-GPE to a plant or plant part can be used in the present invention. Preferably, a compound is provided in a solution for applying onto the plant or plant part. Suitable solvents for making the solutions include but are not limited to water and organic solvents such as alcohol solvents (e.g., isopropanol). Examples of concentrations of an N-acyl-PE, N-acyl-LPE, deoxy N-acyl-LPE, N-acyl-GPE, or deoxy N-acyl-GPE that can be used include those from about 1 mg/L to about 2000 mg/L, from about 10 mg/L to about 1000 mg/L, and from about 20 mg/L to about 500 mg/L. The term “about” is used in the specification and claims to cover concentrations that slightly deviate from a recited concentration but retain its essential function. For treating a target plant or plant part, the plant or plant part can be sprayed with or dipped into a solution described above. Other suitable methods of exposing a plant or plant part to an N-acyl-PE, N-acyl-LPE, deoxy N-acyl-LPE, N-acyl-GPE, or deoxy N-acyl-GPE can also be used.

By way of example, but not limitation, examples of the present invention are described below.

### EXAMPLE 1

### Synthesis of NALPE-2 and NAPE-2

Synthesis of N-acetyl lysophosphatidylethanolamine (NALPE-2). Acetyl chloride (296 μL, 4.16 mmol) in dry chloroform (10 mL) was added dropwise to a solution of lysophosphatidylethanolamine derived from egg lecithin (Doosan Biotech (Seoul, Korea); 1000 mg, 2.076 mmol) and magnesium oxide (1 g) in chloroform (20 mL). The reaction mixture was stirred at room temperature overnight. After filtration of the solution, the filtrate was concentrated in vacuo. The residue was purified by flash column chromatography, eluting with a gradient of chloroform /methanol (9:1) to chloroform /methanol (7:3) to give 618 mg of a waxy solid NALPE-2 (60% yield): R_{f} (retention factor)=0.30 in chloroform /methanol/water (65:25:1); positive spot by phosphorus spay and negative by ninhydrin spray; Fourier Transform Infrared (FT-IR) (neat) cm⁻¹ 3267, 2920, 2851, 1736, 1639, 1564, 1464, 1376, 1231, 1109, and 1049.

Synthesis of N-acetylphosphatidylethanolamine (NAPE-2). A solution of phosphatidylethanolamine isolated from soybean (Avanti Polar Lipids (Alabaster, Ala.); 500 mg, 0.698 mmol) and triethylamine (0.389 mL, 2.79 mmol) in dry chloroform (20 mL) was cooled in ice bath and acetyl chloride (99 μL, 1.40 mmol) in dry chloroform (10 mL) was added dropwise. The reaction mixture was stirred at room temperature overnight and concentrated in vacuo. The residue was purified by flash column chromatography, eluting with a gradient of chloroform /methanol (9:1) to chloroform /methanol (8:2) to give 330 mg of a waxy solid NAPE-2 (62% yield): R_{f}=0.21 in chloroform /methanol (8:2); positive spot by phosphorus spay and negative by ninhydrin spray; FT-IR (neat) cm⁻¹ 2923, 2853, 1736, 1654, 1560,1459,1375,1235, 1106, and 1062.

### EXAMPLE 2

### Effects of NAPE-2 and NALPE-2 on Kinetin-Induced Cotyledon Expansion and Hypocotyls Anthocyanin Level

Methods

Radish cotyledon bioassay. The radish cotyledon bioassay was essentially as described by Letham D S (1971) Physiologia Plantarum 25:391-396, which is herein incorporated by reference in its entirety. Seeds of Raphanus sativus L. cv. Cherry-Belle were germinated in darkness at 25° C. for 36 hours in Petri dishes containing filter paper wetted with distilled water. The smaller of the two cotyledons was excised, the fresh weight determined, and 10 cotyledons placed adaxial side down on filter paper in Petri dishes containing potassium phosphate buffer (2 mM, pH 6.0) with kinetin (0.2 mg/L, added to simulate natural growing conditions) and the compounds to be tested at 20 mg/L. Cotyledons were then incubated under continuous illumination up to 72 hours at 25° C. and the increase in fresh weight determined. Chlorophyll content was determined after extraction of tissue into 80% ethanol (containing butylated hydroxytoluene, 10 mg/L) and quantified spectrophotometrically using the equations Chl a=(13.95A₆₆₃)−(6.88A₆₄₇) and Chl b=(24.96A₆₅₂)−(7.32A₆₆₃) as described by Lichtenthal H K (1987) Methods in Enzymology 148:350-382, which is herein incorporated by reference in its entirety.

Radish hypocotyl bioassay for anthocyanins. An anthocyanin bioassay was developed using intact germinated seeds of radish (Raphanus sativus L. cv. Cherry-Belle). Seeds of radish were germinated in darkness at 25° C. for 40 hours in Petri dishes containing filter paper wetted with distilled water. Whole seedlings were transferred to Petri dishes containing the test solutions in potassium phosphate buffer (2 mM, pH 6.0 containing 0.2 mg/L kinetin to simulate natural growing conditions). The seedlings were incubated under bright light for 28 h prior to extraction of hypocotyl tissue and spectrophotometric quantification of anthocyanins. Anthocyanin content was determined spectrophotometrically after tissue extraction into 99 parts ethanol and 1 part concentrated HCl. The absorbance of the acidic ethanol fraction was measured at 510 nm and the final anthocyanin content calculated using an extinction coefficient of 31.76 mmol cm⁻¹ for raphanisuns (Ishikura N. and Hayashi K. Chromatographic separation and characterization of the component anthocyanins in radish root. Botanical Magazine Tokyo 76:6-13, 1963, which is herein incorporated by reference in its entirety).

Results

Effects of NAPE-2. NAPE-2 was prepared semi-synthetically as described in Example 1 and assayed using the radish cotyledon bioassay. The results in Table 1 show that NAPE-2 increased cotyledon fresh weight by about 10%. NAPE-2 treatment did not change the total amount of chlorophyll during radish cotyledon expansion.

TABLE 1
Effect of NAPE-2 on kinetin-induced expansion growth and chlorophyll
content of radish cotyledons. Three cotyledons were incubated on filter
discs wetted with 2 mM phosphate buffer (PB, pH 6.0) containing kinetin
(0.2 mg/l) and NAPE-2 (20 mg/L). Cotyledons were incubated under continuous
illumination in an incubation chamber at 25° C. for 72 hours and the change in
fresh weight and chlorophyll content determined (n = 3). nd = not determined.

| | Change in fresh | | Chlorophyll | Chlorophyll | |
|---|---|---|---|---|---|
| | weight | | a + b | a + b | Chlorophyll |
| Treatment | (mg) | % of control | (μg/cotyledon) | (mg/g FW) | a/b |
| Control | 17.04 ± 2.34* | 100 | 31.00 ± 2.81 | 1.44 ± 0.03 | 1.80 |
| NAPE-2 | 18.90 ± 1.74* | 110 | 25.99 ± 5.15 | 1.09 ± 0.14 | 1.82 |
| Control | 19.84 ± 4.65* | 100 | nd | nd | nd |
| NAPE-2 | 21.37 ± 1.09* | 108 | nd | nd | nd |
| Control | 20.78 ± 0.49* | 100 | nd | nd | nd |
| NAPE-2 | 22.52 ± 3.42* | 108 | nd | nd | nd |

*Data are significant (p = 0.05)

Effects of NALPE-2. As shown in Table 2, NALPE-2 displayed inhibitory activity on expansion growth of radish cotyledons and the degree of inhibition was dependent upon the concentration of applied NALPE-2. In Table 3, it is shown that NALPE-2 enhanced the amount of anthocyanin pigment in radish hypocotyls.

TABLE 2
Effect of NALPE-2 on cotyledon expansion in radish. Cotyledons
were incubated on filter discs wetted with 2 mM PB (pH 6.0)
containing kinetin (0.2 mg/l) and incubated under continuous
illumination in an incubation chamber at 25° C. for 72 hours and
the change in fresh weight determined (n = 9).

| | Change in fresh weight | % of |
|---|---|---|
| Treatment | (mg) | control |
| Control | 14.91 ± 4.10 | 100 |
| NALPE-2 (0.2 mg/l) | 13.68 ± 4.79 | 92 |
| NALPE-2 (20 mg/l) | 9.88 ± 4.93 | 66 |
| NALPE-2 (200 mg/l) | 8.64 ± 5.46 | 58 |

TABLE 3
Effect of NALPE-2 on hypocotyls anthocyanin content of radish.
Whole germinated seedlings were incubated on filter discs wetted
with 2 mM PB (pH 6.0) containing kinetin (0.2 mg/l) and incubated
under continuous illumination in an incubation chamber at
25° C. for 28 hours. The change in hypocotyls anthocyanin
content was determined (n = 4).

| Treatment | Anthocyanin (μg/hypocotyl) | % of control |
|---|---|---|
| Control | 2.107 ± 0.001 | 100 |
| NALPE-2 (15 mg/l) | 2.637 ± 0.005 | 125 |

### EXAMPLE 3

### The Color Impact of NALPE-2 on Tomato and Hot Pepper

Methods

The color impact of NALPE-2 on tomato. Hydroponic tomatoes (var. Trust) in a commercial greenhouse located in Arena, Wis. were treated with NALPE-2 (50 mg/L) using a hand pump spray bottle. Five tomato clusters each with 3-5 fruit in the early ripening stages (breaker) were used. The clusters were sprayed such that little overspray left the immediate area as to not contaminate other vines. Ambient conditions in the greenhouse at the time of application were about 75° F. and 70% relative humidity, full sun. Drying time was approximately 0.5 hr. Fruit were harvested after 7 days and transported to the laboratory for visual color comparison.

The color impact of NALPE-2 on hot pepper. Potted ornamental peppers (var. Bolivian Rainbow Peppers) in laboratory greenhouses located in Middleton, Wis. were treated with NALPE-2 (50 mg/L). The plants were grown from seed and allowed to mature until the plant crown showed substantial fruit numbers. 40-50 fruits were tagged and labeled. The pepper color stage was noted prior to application and two plants were used. Ambient conditions in the greenhouse at the time of application were about 80° F. and 70% relative humidity. Drying time was approximately 0.5 hr. After 14 days the peppers were harvested and color group sorting was performed.

Results

As shown in Tables 4 and 5, NALPE-2 accelerated color development in tomatoes and hot peppers.

TABLE 4
Effect of NALPE-2 on color development of tomatoes.
NALPE-2 (50 mg/L) was applied 7 days prior to harvest
and visual color comparison.

| | Color Stage | | |
|---|---|---|---|
| | Others¹ | Light Red | Red |
| Treatment | (%) | (%) | (%) |
| Untreated control | 47 | 20 | 33 |
| NALPE-2 (50 mg/L) | 16 | 17 | 67 |

¹Others: Tomatoes of breaker, turning, and pink stage.

TABLE 5
Effect of NALPE-2 on color development of Bolivian Rainbow
Peppers. NALPE-2 (50 mg/L) was applied 14 days prior to
harvest and color group sorting. The order of color development for
Bolivian Rainbow Peppers is purple, blue, yellow, orange, and red.

| | Color Stage | | | | |
|---|---|---|---|---|---|
| | Purple | Blue | Yellow | Orange | Red |
| Treatment | (%) | (%) | (%) | (%) | (%) |
| Untreated control | 27 | 26 | 14 | 14 | 19 |
| NALPE-2 (50 mg/L) | 19 | 22 | 6 | 20 | 32 |

1. A compound having the formula R¹OCH₂—R²CH—CH₂OP(O)(OH)O—CH₂CH₂N(R³)—COR⁴, wherein R^{1 and R}³ are hydrogen or carbon chains of one to 24 carbons, R² is hydrogen or a group having the formula R⁵O wherein R⁵ is hydrogen or a carbon chain of one to 24 carbons, and R⁴ is hydrogen or a carbon chain of one to 23 carbons; the carbon chains can be saturated, unsaturated, linear, branched, cyclic, or polycyclic; and the carbon chains can have heteroatoms.

2. The compound of claim 1, wherein at least one of R¹ and R³-R⁵is an alkyl, alkenyl, or alkynyl substituted with a substituent selected from the group consisting of a halogen, an amino, an alkoxy, a carboxy, an alkoxycarbonyl, an alkylcarbonyl, and a hydroxy.

3. The compound of claim 1, wherein one or more of the carbon atoms in at least one of R¹ and R³-R⁵ is replaced by a constituent selected from the group consisting of an ester group, a nitrile, an amine, an amine salt, an acid, an acid salt, an ester of acids, a hydroxyl group, a halogen group, and a heteroatom selected from the group consisting of an oxygen, a sulfur, a nitrogen, and a phosphorus.

4. A method for achieving an ethylene-like or cytokinin-like effect on a plant or plant part, the method comprising the step of treating the plant or plant part with a composition that comprises a compound of claim 1 in an amount effective to deliver the ethylene-like or cytokinin-like effect.

5. The method of claim 4, wherein the concentration of the compound in the composition is from about 1 mg/L to about 2,000 mg/L.

6. The method of claim 4, wherein the concentration of the compound in the composition is from about 10 mg/L to about 1,000 mg/L.

7. The method of claim 4, wherein the concentration of the compound in the composition is from about 20 mg/L to about 500 mg/L.

8. The method of claim 4, wherein treating the plant or plant part with the composition is accomplished through a method selected from the group consisting of spraying the plant or plant part with the composition and dipping the plant or plant part into the composition.

9. The method of claim 4, wherein the plant part is selected from a fruit, a flower, a seed, a leaf, a root, a stem, a tuber, or a bulb.

10. The method of claim 4, wherein the method is for achieving an ethylene-like effect.

11. The method of claim 10, wherein the ethylene-like effect is enhancement of ripening or maturation of a plant part.

12. The method of claim 10, wherein the plant part is treated with the composition before it is harvested from a growing plant.

13. The method of claim 10, wherein the plant part is treated with the composition after it is harvested from a growing plant.

14. The method of claim 4, wherein the method is for achieving a cytokinin-like effect.

15. A method for promoting the growth of a plant or plant part, the method comprising the step of treating the plant or plant part with a composition that comprises a compound of claim 1 in an amount effective to promote the growth of the plant or plant.

16. The method of claim 15, wherein the plant part is selected from a fruit, a flower, a seed, a leaf, a root, a stem, a tuber, or a bulb.

17. The method of claim 15, wherein the number of the plant or plant part is increased.

18. The method of claim 15, wherein the size or weight of the plant part is increased.

19. The method of claim 18, wherein the plant part is a fruit.

20. The method of claim 16, wherein the plant part is a root.

21. The method of claim 15, wherein the composition is used to enhance root formation and development of roots on cuttings by treating the cuttings with the composition.

22. The method of claim 15, wherein the composition is used to enhance tuber or bulb formation by treating a plant or a part thereof with the composition.

23. A method for promoting color development in a plant part, the method comprising the step of treating the plant or plant part with a composition that comprises a compound of claim 1 in an amount effective to promote color development in the plant part.

24. The method of claim 23, wherein the plant part is a fruit.
